(19) United States
(12) Patent Application Publication
(10) Pub. No.: US 2025/0242576 A1
(43) Pub. Date: Jul. 31, 2025

(54) HIGH-BARRIER INFLATABLE CUSHION AND PREPARATION PROCESS THEREFOR

(71) Applicant: Guangzhou Yuanqi Dynamic Technology Co., LTD, Guangzhou (CN)

(72) Inventor: Kuihu CHENG, Guangzhou (CN)

(73) Assignee: Guangzhou Yuanqi Dynamic Technology Co., LTD, Guangzhou (CN)

(21) Appl. No.: 19/079,398

(22) Filed: Mar. 13, 2025

(30) Foreign Application Priority Data
Nov. 23, 2024 (CN) 202411685951.7

(51) Int. Cl. B32B 27/30; A45F 3/12; A61G 7/057; A61H 1/00; B29C 48/00; B29C 48/08; B29C 48/21; B29K 29/00; B29K 75/00; B29L 31/58; B32B 5/02; B32B 27/08; B32B 27/12; B32B 27/40; B62J 1/18; C08F 210/02; C08J 3/21; C08J 5/12; C08K 9/06; C09C 1/44; C09C 3/12; C09J 5/06

(52) U.S. Cl. CPC B32B 27/306; A45F 3/12; A61G 7/05769; A61H 1/005; B29C 48/0021; B29C 48/08; B29C 48/21; B32B 5/022; B32B 27/08; B32B 27/12; B32B 27/40; C08F 210/02; C08J 3/212; C08J 5/128; C08K 9/06; C09C 1/44; C09C 3/12; C09J 5/06; A61H 2201/0103; A61H 2201/1207; B29K 2029/00; B29K 2075/00; B29K 2995/0067; B29L 2031/58; B32B 2262/0292; B32B 2274/00; B32B 2307/718; B32B 2307/7376; B32B 2535/00; B32B 2605/00; B62J 1/18; C08J 2323/08; C08J 2375/04

(57) ABSTRACT

Disclosed are a high-barrier inflatable cushion and a preparation process therefor, which related to the technical fields of high-barrier inflatable cushions. The preparation process includes the following steps: material feeding, heating, vacuum counter-pressure molding, spray cooling, air cooling and drying, die-cutting, and thermal bonding. The high-barrier inflatable cushion comprises an airbag forming material and an airbag base material. The airbag forming material is prepared by laminating a TPU-EVOH composite with Lycra fabric, the TPU-EVOH composite has a total thickness of 0.4-0.8 mm, and the Lycra fabric has a gram weight of 150-230 g/m². The airbag base material is prepared by laminating the TPU-EVOH composite with non-woven fabric, the TPU-EVOH composite has a total thickness of 0.1-0.3 mm, and the non-woven fabric has a gram weight of 60-80 g/m².

### CROSS-REFERENCE TO RELATED APPLICATIONS

This application claims priority to Chinese Patent Application No. 202411685951.7 with a filing date of Nov. 23, 2024. The content of the aforementioned application, including any intervening amendments thereto, is incorporated herein by reference.

### TECHNICAL FIELD

The present disclosure relates to the technical field of high-barrier inflatable cushions, and specifically relates to a high-barrier inflatable cushion and a preparation process therefor.

### BACKGROUND

With the growing market demand for high-performance materials in the packaging industry, inflatable cushions as an important protective material have been widely applied to the fields of electronic products, pharmaceutical packaging, food transport and the like. Traditional inflatable cushions are mainly made from materials such as polyethylene (PE) and polypropylene (PP), and these materials usually possess certain cushioning and impact resistance. However, these materials exhibit significant deficiencies in gas barrier properties and mechanical properties, thereby limiting their performance in high-end applications.

In the prior art, an ethylene-vinyl alcohol copolymer (EVOH) is a material with excellent gas barrier properties and is usually applied to the fields of food packaging, pharmaceutical packaging and the like. EVOH can effectively prevent permeation of gases such as oxygen and carbon dioxide, extend shelf lives of products and enhance storage stability thereof. However, although having outstanding gas barrier properties, EVOH has poor water resistance and is easily affected by humidity, thereby resulting in degradation of barrier properties in humid environments. Additionally, EVOH is quite brittle, and can hardly meet the requirements for flexibility and toughness of inflatable cushions in practical applications. Therefore, standalone use of EVOH in inflatable cushions makes it difficult to ensure good gas barrier properties and mechanical properties simultaneously.

Moreover, thermoplastic polyurethane (TPU), due to excellent elasticity, abrasion resistance, and tensile strength, is widely applied to the fields that require high mechanical properties. In the application of inflatable cushions, TPU exhibits good cushioning effects and durability, but shows relatively poor gas barrier properties. TPU does not possess superior gas barrier properties of EVOH, resulting in that properties of inflatable cushions against moisture and oxidation are relatively poor, and the problem of gas permeation caused by prolonged exposure to air cannot be effectively solved. Therefore, deficiencies of traditional materials in gas barrier properties and mechanical properties pose challenges for high-demand applications of inflatable cushions of the prior art.

To solve the above problems, the present disclosure reasonably selects a combination of EVOH and TPU materials, aiming to enhance the gas barrier properties of inflatable cushions while improving mechanical properties thereof. Combination of the gas barrier properties of EVOH with elasticity and mechanical strength of TPU enables to achieve stronger mechanical support and a longer service life on the basis of maintaining good gas barrier properties, such that a high-performance inflatable cushion material is available.

### SUMMARY

In view of the above problems in the prior art, an objective of the present disclosure is to provide a high-barrier inflatable cushion and a preparation process therefor.

To achieve the above objective, the present disclosure provides the following technical solution:
a preparation process for a high-barrier inflatable cushion, including the following steps:
S1: material feeding: feeding an airbag forming material with a TPU layer unwound upward;
S2: heating: moving the airbag forming material to a heating chamber for heating;
S3: vacuum counter-pressure molding: after the heating, moving the airbag forming material to a molding chamber for vacuum adsorption and counter-pressure molding;
S4: spray cooling: after the molding, moving the airbag forming material to a spray chamber for spray cooling;
S5: air cooling and drying: after cooling, moving the airbag forming material to an air drying chamber for air cooling and drying;
S6: die-cutting: after the drying, moving the airbag forming material to a cutting area for cutting to obtain a semi-finished airbag product;
S7: thermal bonding: thermally bonding one semi-finished airbag product with one airbag base material to obtain a high-barrier inflatable cushion; and
further, the airbag forming material is prepared by laminating a TPU-EVOH composite with Lycra fabric, and the airbag base material is prepared by laminating the TPU-EVOH composite with non-woven fabric.

Further, in the S2, a heating temperature is 350-400° C., and a heating duration is 15-30 sec;
further, in the S3, a duration of the vacuum adsorption is 10-60 sec, and a duration of the counter-pressure molding is 80-100 sec;
further, in the S4, a spray pressure during the spray cooling is 0.2-0.5 MPa, and a spray duration is 1-5 sec; and
further, in the S5, a duration of the air cooling and drying is 50-100 sec.

Further, in the airbag forming material, the TPU-EVOH composite has a total thickness of 0.4-0.8 mm, and the Lycra fabric has a gram weight of 150-230 g/m²; and
further, in the airbag base material, the TPU-EVOH composite has a total thickness of 0.1-0.3 mm, and the non-woven fabric has a gram weight of 60-80 g/m².

Further, a preparation method for the airbag forming material or the airbag base material includes the following steps:
co-extruding the EVOH material and the TPU material to obtain a TPU-EVOH composite; coating a moisture-curable polyurethane reactive (PUR) hot melt adhesive on an EVOH surface of the TPU-EVOH composite to obtain a bonding layer, heating the bonding layer to 120-140° C., laminating the Lycra fabric or the non-woven fabric on the EVOH surface, allowing same to stand for 24 h, and curing in an environment of 50-70% humidity and 15-30° C. for 4-7 d, to obtain the airbag forming material or the airbag base material; and the TPU material has a thickness of 0.15-0.8 mm, the EVOH material has a thickness of 0.02-0.05 mm, and the bonding layer has a peeling strength of 35-60 N.

Further, the EVOH material includes any one of EVOH, an EVOH copolymer, and an EVOH nanocomposite.

Further, a preparation method for the EVOH copolymer includes the following steps: adding (Z)-3-bromo-1-cyclooctene into a mixture of acetone and an aqueous sodium bicarbonate solution, heating and refluxing for 1-1.5 h, filtering and concentrating a filtrate, extracting with diethyl ether, separating an ether phase, drying and concentrating, and performing vacuum distillation to obtain 3-hydroxy-1-cyclooctene; adding the 3-hydroxy-1-cyclooctene and pyridine into dichloromethane, adding acetyl chloride under ice-bath conditions, stirring at room temperature for 3-3.5 h, adding a reaction mixture into 2 mol/L of a hydrochloric acid solution, separating an organic phase, extracting an aqueous phase with dichloromethane, washing the combined organic phase with a saturated aqueous sodium bicarbonate solution, drying with magnesium sulfate and concentrating, and performing vacuum distillation to obtain (Z)-cyclooct-2-ene-1-yl acetate; and
adding (Z)-cyclooct-2-ene-1-yl acetate into a reaction vessel, adding toluene, degassing through three cycles of freezing-pumping-thawing, adding argon, heating same to 40-42° C., adding a second-generation GRUBBS catalyst, maintaining a reaction for 24 h, adding ethyl vinyl ether to quench the reaction, adding the reaction mixture into methanol to separate the polymer, adding the polymer to dichloromethane, reprecipitating and purifying the polymer in methanol, adding 2,6-di-tert-butyl-p-cresol to the polymer, and performing vacuum drying at 70-72° C. for 24 h to obtain a polyolefin monomer, and hydrogenating and deprotecting the polyolefin monomer to obtain an EVOH copolymer.

Further, the hydrogenation process includes the following steps: adding the polyolefin monomer into a container, adding xylene, 2,6-di-tert-butyl-p-cresol, and tributylamine, stirring evenly, adding p-toluenesulfonyl hydrazide, heating same to 140-145° C. and refluxing for 8 h, cooling to room temperature, performing rotary evaporation, adding a mixed product into methanol for precipitation and purification, and performing vacuum drying at 70° C. for 24 h to obtain an intermediate.

Further, the deprotection process includes the following steps: adding the intermediate into tetrahydrofuran, adding a 25 wt % sodium methoxide solution, stirring before reaction for 24 h, adding acidic methanol until a reaction pH is acidic, filtering, washing the filtrate with methanol, adding same into methanol for precipitation and purification, adding the polymer to hexafluoroisopropanol, heating same to 50° C. for dissolving, and performing vacuum drying at 70° C. for 24 h to obtain the EVOH copolymer.

Further, a preparation method for the second-generation GRUBBS catalyst includes the following steps: adding the second-generation GRUBBS catalyst into a container, evacuating, purging with argon, then adding toluene and stirring evenly.

Further, in the preparation process of 3-hydroxy-1-cyclooctene, a concentration of the aqueous sodium bicarbonate solution is 0.03 mol/L; in the preparation process of (Z)-cyclooct-2-ene-1-yl acetate, a molar ratio of 3-hydroxy-1-cyclooctene to pyridine to acetyl chloride is 0.1:0.15:0.15; and in the preparation process of the EVOH copolymer, a molar ratio of (Z)-cyclooct-2-ene-1-yl acetate to the second-generation GRUBBS catalyst is 29.7:0.0074.

Further, a preparation method for the EVOH nanocomposite includes the following steps:
adding a hybrid nanofiller into deionized water, performing ultrasonic dispersion, adding a Tris-HCl buffer solution, stirring evenly, adding an aqueous dopamine hydrochloride solution, stirring before reaction for 24 h, centrifuging to collect solid products, and freeze-drying to obtain a dopamine-modified hybrid nanofiller;
adding the EVOH copolymer into N,N-dimethylformamide, heating to 70-72° C. and stirring evenly, cooling to room temperature, sequentially adding the dopamine-modified hybrid nanofiller and an aqueous boric acid solution, performing ultrasonic dispersion, adding a mixture into a polytetrafluoroethylene container, heating to 70-72° C. for vacuum thermal treatment for 6-7 h, performing hydrazine vapor treatment, and performing vacuum drying at 50-70° C. to obtain the EVOH nanocomposite.

Further, the hybrid nanofiller is prepared from 3-aminopropyltriethoxysilane modified MXene and graphene oxide.

Further, in the preparation process of the dopamine-modified hybrid nanofiller, the Tris-HCl buffer solution has a pH value of 8.5; and in the preparation process of the EVOH nanocomposite, an amount of the dopamine-modified hybrid nanofiller added is 5-10 wt % of a mass of the EVOH copolymer, and an amount of boric acid added is 5-20 wt % of the mass of the EVOH copolymer.

Further, a preparation method for the hybrid nanofiller includes the following steps: adding lithium fluoride into a 9M hydrochloric acid solution, stirring evenly, adding titanium carbide aluminum powder under ice-bath conditions, heating to 35-36° C. for a reaction of 24 h, washing a reaction suspension with deionized water, centrifuging to collect a precipitate, washing the precipitate to neutral pH, performing ultrasonic dispersion of the precipitate in deionized water, centrifuging to collect a supernatant, purging with nitrogen, and freeze-drying to obtain MXene; and
adding MXene into an aqueous ethanol solution, performing ultrasonic dispersion under nitrogen conditions, adjusting a pH value of the suspension to 3-4, adding 3-aminopropyltriethoxysilane, stirring at room temperature for a reaction of 24 h, washing the suspension with ethanol, centrifuging, and freeze-drying to obtain modified MXene; and adding the modified MXene and graphene oxide into N,N-dimethylformamide, performing ultrasonic dispersion under the nitrogen conditions, adding carbodiimide, 1-hydroxybenzotriazole hydrate, and N,N-diisopropylethylamine, reacting under the nitrogen conditions for 24 h, washing a product with N,N-dimethylformamide and deionized water, and freeze-drying to obtain the hybrid nanofiller.

Further, in the preparation process of the MXene, a mass ratio of lithium fluoride to titanium carbide aluminum is 1.95:2.9; in the preparation process of modified MXene, a mass ratio of MXene to 3-aminopropyltriethoxysilane is 1:2; and in the preparation process of the hybrid nanofiller, a mass ratio of modified MXene to graphene oxide to carbodiimide to 1-hydroxybenzotriazole hydrate to N,N-diisopropylethylamine is 125:125:67:67:1.

Compared with the prior art, the present disclosure has the beneficial effects as follows:
1. In the present disclosure, controllable polymerization of cyclic olefins is achieved through ring-opening metathesis polymerization of (Z)-3-bromo-1-cyclooctene, and then an EVOH copolymer with regional regularity of molecular structure is prepared through hydrogenation and deprotection, which is different from a conventional commercially available EVOH (EVOH-44 contains 44 mol % ethylene units, and EVOH-32 contains 32 mol % ethylene units). The EVOH copolymer prepared by the present disclosure contains 75 mol % ethylene units that are arranged in a linear and highly regular manner, and enables an inflatable cushion to have excellent gas barrier properties.
2. In the present disclosure, to further enhance the gas barrier properties and mechanical properties of the inflatable cushion based on the above EVOH copolymer, a self-made dopamine-modified hybrid nanofiller is added to the EVOH copolymer, and boric acid as a crosslinking agent is added to induce crosslinking. Boric acid ions induce crosslinking between the EVOH copolymer and the dopamine-modified hybrid nanofiller, which enhances an interfacial interaction between the filler and matrix resin. A crosslinked network is formed between the EVOH copolymer, the boric acid, and the dopamine-modified hybrid nanofiller. Additionally, during thermal treatment crosslinking, the dopamine-modified hybrid nanofiller can also crosslink with the dopamine-modified hybrid nanofiller through the action of boric acid, such that a transverse or vertical spacing between the layered fillers is reduced, thereby increasing complexity of gas channels. Introduction of composite fillers enables the inflatable cushions to have excellent gas barrier properties, mechanical properties, and thermal stability.
3. The hybrid nanofiller in the dopamine-modified hybrid nanofiller is prepared by covalently bonding MXene and graphene oxide through 3-aminopropyltriethoxysilane. The hybrid nanofiller has a larger hybrid interlayer spacing than those of pristine MXene and graphene oxide, which facilitates subsequent dopamine modification and boric acid ion infiltration for crosslinking with the EVOH copolymer, enhances subsequent crosslinking network density and interfacial interactions, and improves the gas barrier properties and mechanical properties.

### BRIEF DESCRIPTION OF THE DRAWINGS

FIG. 1 is a schematic diagram showing a preparation process for a high-barrier inflatable cushion according to the present disclosure.

FIG. 2 is a schematic diagram showing a 36-cell cushion structure of a high-barrier inflatable cushion according to the present disclosure.

FIG. 3 is a schematic diagram showing a 49-cell cushion structure of a high-barrier inflatable cushion according to the present disclosure.

FIG. 4 is a schematic diagram showing an anti-decubitus cushion structure of a high-barrier inflatable cushion according to the present disclosure.

FIG. 5 is a schematic diagram showing a shoulder strap structure of a high-barrier inflatable cushion according to the present disclosure.

FIG. 6 is a schematic diagram showing a bicycle cushion structure of a high-barrier inflatable cushion according to the present disclosure.

FIG. 7 is a schematic diagram showing a double-sided cushion structure of a high-barrier inflatable cushion according to the present disclosure.

FIG. 8 is a schematic diagram showing an electric massage cushion structure of a high-barrier inflatable cushion according to the present disclosure.

### DETAILED DESCRIPTIONS OF THE EMBODIMENTS

The technical solutions in the examples of the present disclosure will be clearly and completely described below in combination with the accompanying drawings in the examples of the present disclosure. Apparently, the examples described are merely some rather than all of the examples of the present disclosure. All other examples acquired by those of ordinarily skilled in the art without making creative efforts based on the examples of the present disclosure fall within the scope of protection of the present disclosure.

In the following examples, a conventional commercially available EVOH containing 32 mol % ethylene, is purchased from Sigma-Aldrich; a TPU HF-1380A is purchased from Huafon Group; Lycra fabric is purchased from Lycra Company; non-woven fabric is purchased from Shandong Huaye Nonwoven Fabric Co., Ltd.; a moisture-curable PUR hot melt adhesive 3930 is purchased from Kain Chemical; (Z)-3-bromo-1-cyclooctene CAS: 7422-06-2; graphene oxide is purchased from Sigma-Aldrich; dopamine hydrochloride is purchased from Aladdin; and other raw materials are commercially available.

In the following examples, a preparation method for a hybrid nanofiller includes the following steps: add 1.95 g of lithium fluoride into 60 mL of a 9M hydrochloric acid solution, stir evenly, add 2.9 g of titanium carbide aluminum powder under ice-bath conditions, heat to 35° C. for a reaction of 24 h, wash a reaction suspension with deionized water, centrifuge to collect a precipitate, wash the precipitate to neutral pH, perform ultrasonic dispersion of the precipitate in deionized water, centrifuge to collect a supernatant, purge with nitrogen, and freeze-dry to obtain MXene; and
add 100 mg of MXene into an aqueous ethanol solution with a volume ratio of 9:1, perform ultrasonic dispersion under nitrogen conditions, adjust a pH value of the suspension to 3, add 200 mg of 3-aminopropyltriethoxysilane, stir at room temperature for a reaction of 24 h, wash the suspension with ethanol, centrifuging, and freeze-dry to obtain modified MXene; and add 125 mg of the modified MXene and 125 mg of graphene oxide into 50 mL of N,N-dimethylformamide, perform ultrasonic dispersion under the nitrogen conditions, add 67 mg of carbodiimide,67 mg of 1-hydroxybenzotriazole hydrate, and 1 g of N,N-diisopropylethylamine, react under the nitrogen conditions for 24 h, wash a product with N,N-dimethylformamide and deionized water, and freeze-dry to obtain the hybrid nanofiller.

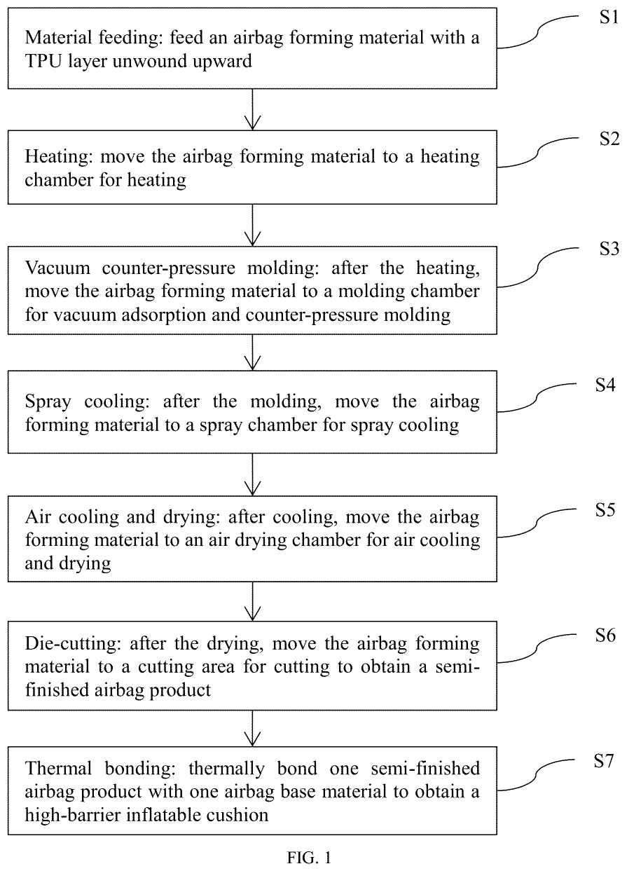

Example 1: with reference to FIG. 1, a preparation process for a high-barrier inflatable cushion, includes the following steps: S1: material feeding: feed an airbag forming material with a TPU layer unwound upward;
S2: heating: move the airbag forming material to a heating chamber for heating at 130° C. for 15 sec;
S3: vacuum counter-pressure molding: after the heating, move the airbag forming material to a molding chamber for vacuum adsorption for 10 sec and counter-pressure molding for 80 sec;
S4: spray cooling: after the molding, move the airbag forming material to a spray chamber for spray cooling at a spray pressure of 0.2 MPa for 1 sec;
S5: air cooling and drying: after cooling, move the airbag forming material to an air drying chamber for air cooling and drying for 50 sec;
S6: die-cutting: after the drying, move the airbag forming material to a cutting area for cutting to obtain a semi-finished airbag product; and
S7: thermal bonding: thermally bond one semi-finished airbag product with one airbag base material to obtain a high-barrier inflatable cushion.

A preparation method for the airbag forming material includes the following steps: co-extrude the EVOH material and the TPU material to obtain a TPU-EVOH composite; coat a moisture-curable PUR hot melt adhesive on an EVOH surface of the TPU-EVOH composite to obtain a bonding layer, heat the bonding layer to 120° C., laminate the Lycra fabric on the EVOH surface, allow same to stand for 24 h, and cure in an environment of 50% humidity and 20° C. for 4 d, to obtain the airbag forming material; and the TPU-EVOH composite has a total thickness of 0.4 mm, and the Lycra fabric has a gram weight of 150 g/m².

A preparation method for the airbag base material includes the following steps: co-extrude the EVOH material and the TPU material to obtain a TPU-EVOH composite; coat a moisture-curable PUR hot melt adhesive on an EVOH surface of the TPU-EVOH composite to obtain a bonding layer, heat the bonding layer to 120° C., laminate the non-woven fabric on the EVOH surface, allow same to stand for 24 h, and cure in an environment of 50% humidity and 20° C. for 4 d, to obtain the airbag base material; and the TPU-EVOH composite has a total thickness of 0.1 mm, and the non-woven fabric has a gram weight of 60 g/m².

In the preparation process of the airbag forming material and the airbag base material, the EVOH is a conventional commercially available EVOH.

Example 2: A preparation process for a high-barrier inflatable cushion: in the preparation process of the airbag forming material and the airbag base material, the EVOH is an EVOH copolymer;

A preparation process for the EVOH copolymer includes the following steps: add 25 g of (Z)-3-bromo-1-cyclooctene into a mixture of 200 mL of acetone and 100 mL of an 0.03 mol/L aqueous sodium bicarbonate solution, heat and reflux for 1 h, filter and concentrate a filtrate, extract with diethyl ether, separate an ether phase, dry and concentrating, and perform vacuum distillation to obtain 3-hydroxy-1-cyclooctene; add 0.1 mol of the 3-hydroxy-1-cyclooctene and 0.15 mol of pyridine into 200 mL of dichloromethane, add 0.15 mol of acetyl chloride under ice-bath conditions, stir at room temperature for 3 h, add a reaction mixture into 2 mol/L of a hydrochloric acid solution, separate an organic phase, extract an aqueous phase with dichloromethane, wash the combined organic phase with a saturated aqueous sodium bicarbonate solution, dry with magnesium sulfate and concentrating, and perform vacuum distillation to obtain (Z)-cyclooct-2-ene-1-yl acetate; and
add 29.7 mmol of (Z)-cyclooct-2-ene-1-yl acetate into a reaction vessel, add 20 mL of toluene, degas through three cycles of freezing-pumping-thawing, add argon, heat same to 40° C., add 0.0074 mmol of a second-generation GRUBBS catalyst, maintain a reaction for 24 h, add 1 mL of ethyl vinyl ether to quench the reaction, add the reaction mixture into methanol to separate the polymer, add the polymer to dichloromethane, reprecipitate and purify the polymer in methanol, add 2 mg of 2,6-di-tert-butyl-p-cresol to the polymer, and perform vacuum dry at 70° C. for 24 h to obtain a polyolefin monomer, and hydrogenate and deprotect the polyolefin monomer to obtain an EVOH copolymer.

The hydrogenation process includes the following steps: add 40.5 mmol of the polyolefin monomer into a container, add 250 mL of xylene, 80 mg of 2,6-di-tert-butyl-p-cresol, and 29 mL of tributylamine, stir evenly, add p-toluenesulfonyl hydrazide, heat same to 140° C. and reflux for 8 h, cool to room temperature, perform rotary evaporation, add a mixed product into methanol for precipitation and purification, and perform vacuum dry at 70° C. for 24 h to obtain an intermediate.

The deprotection process includes the following steps: add 6.2 g of the intermediate into tetrahydrofuran, add 16 g of a 25 wt % sodium methoxide solution, stir before reaction for 24 h, add acidic methanol until a reaction pH is acidic, filtering, wash the filtrate with methanol, add the polymer to hexafluoroisopropanol, heat same to 50° C. for dissolving, add same into methanol for precipitation and purification, and perform vacuum drying at 70° C. for 24 h to obtain the EVOH copolymer.

A preparation method for the second-generation GRUBBS catalyst includes the following steps: add 0.0074 mmol of the second-generation GRUBBS catalyst into a container, evacuating, purge with argon, then add 1 mL of toluene and stir evenly.

The remaining steps are the same as those in Example 1.

Example 3: A preparation process for a high-barrier inflatable cushion: in the preparation process of the airbag forming material and the airbag base material, the EVOH is an EVOH nanocomposite;
a preparation method for the EVOH nanocomposite includes the following steps: add 100 mg of a hybrid nanofiller into 250 mL of deionized water, perform ultrasonic dispersion, add 100 mL of a Tris-HCl buffer solution, stir evenly, add 100 mL of an aqueous dopamine hydrochloride solution, stir before reaction for 24 h, centrifuge to collect solid products, and freeze-dry to obtain a dopamine-modified hybrid nanofiller;
add 100 g of the EVOH copolymer into N,N-dimethylformamide, heat to 70° C. and stir evenly, cool to room temperature, sequentially add 5 g of the dopamine-modified hybrid nanofiller and an aqueous solution containing 5 g of boric acid, perform ultrasonic dispersion, add a mixture into a polytetrafluoroethylene container, heat to 70° C. for vacuum thermal treatment for 6 h, perform hydrazine vapor treatment, and perform vacuum drying at 50° C. to obtain the EVOH nanocomposite.

The remaining steps are the same as those in Example 1.

Example 4: A preparation process for a high-barrier inflatable cushion: in the preparation process of the airbag forming material and the airbag base material, the EVOH is an EVOH nanocomposite;
a preparation method for the EVOH nanocomposite comprises the following steps: add 100 mg of a hybrid nanofiller into 250 mL of deionized water, perform ultrasonic dispersion, add 100 mL of a Tris-HCl buffer solution, stir evenly, add 100 mL of an aqueous dopamine hydrochloride solution, stir before reaction for 24 h, centrifuge to collect solid products, and freeze-dry to obtain a dopamine-modified hybrid nanofiller;
add 100 g of the EVOH copolymer into N,N-dimethylformamide, heat to 70° C. and stir evenly, cool to room temperature, sequentially add 7 g of the dopamine-modified hybrid nanofiller and an aqueous solution containing 15 g of boric acid, perform ultrasonic dispersion, add a mixture into a polytetrafluoroethylene container, heat to 70° C. for vacuum thermal treatment for 6 h, perform hydrazine vapor treatment, and perform vacuum drying at 50° C. to obtain the EVOH nanocomposite.

The remaining steps are the same as those in Example 1.

Example 5: A preparation process for a high-barrier inflatable cushion: in the preparation process of the airbag forming material and the airbag base material, the EVOH is an EVOH nanocomposite;
a preparation method for the EVOH nanocomposite comprises the following steps: add 100 mg of a hybrid nanofiller into 250 mL of deionized water, perform ultrasonic dispersion, add 100 mL of a Tris-HCl buffer solution, stir evenly, add 100 mL of an aqueous dopamine hydrochloride solution, stir before reaction for 24 h, centrifuge to collect solid products, and freeze-dry to obtain a dopamine-modified hybrid nanofiller;
add 100 g of the EVOH copolymer into N,N-dimethylformamide, heat to 70° C. and stir evenly, cool to room temperature, sequentially add 7 g of the dopamine-modified hybrid nanofiller and an aqueous solution containing 20 g of boric acid, perform ultrasonic dispersion, add a mixture into a polytetrafluoroethylene container, heat to 70° C. for vacuum thermal treatment for 6 h, perform hydrazine vapor treatment, and perform vacuum drying at 50° C. to obtain the EVOH nanocomposite.

The remaining steps are the same as those in Example 1.

Example 6: A preparation process for a high-barrier inflatable cushion: in the preparation process of the airbag forming material and the airbag base material, the EVOH is an EVOH nanocomposite;
a preparation method for the EVOH nanocomposite includes the following steps: add 100 mg of a hybrid nanofiller into 250 mL of deionized water, perform ultrasonic dispersion, add 100 mL of a Tris-HCl buffer solution, stir evenly, add 100 mL of an aqueous dopamine hydrochloride solution, stir before reaction for 24 h, centrifuge to collect solid products, and freeze-dry to obtain a dopamine-modified hybrid nanofiller;
add 100 g of the EVOH copolymer into N,N-dimethylformamide, heat to 70° C. and stir evenly, cool to room temperature, sequentially add 10 g of the dopamine-modified hybrid nanofiller and an aqueous solution containing 20 g of boric acid, perform ultrasonic dispersion, add a mixture into a polytetrafluoroethylene container, heat to 70° C. for vacuum thermal treatment for 6 h, perform hydrazine vapor treatment, and perform vacuum drying at 50° C. to obtain the EVOH nanocomposite.

The remaining steps are the same as those in Example 1.

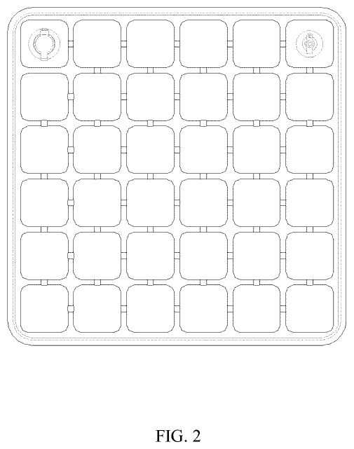

Example 7: A preparation process for a high-barrier inflatable cushion: a 36-cell cushion prepared according to the method disclosed in Example 1 is shown in FIG. 2.

The 36-cell cushion is formed through vacuum adsorption and counter-pressure molding of an airbag forming material by using a mold with 36 airbag positions, after cutting and thermal bonding, where a fabric substrate layer is added at a bottom surface thereof and sewn around edges thereof, and a built-in inflation valve and a built-in deflation valve are arranged on a back face of either of two corner airbags. Due to high-barrier properties of the airbag material of the present disclosure, the 36-cell cushion is inflated for less times during use, brings about comfort and has a long service life.

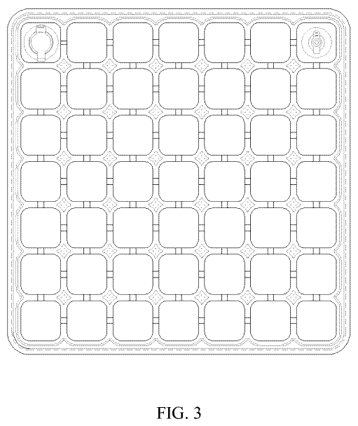

Example 8: A preparation process for a high-barrier inflatable cushion: a 49-cell cushion prepared according to the method disclosed in Example 1 is shown in FIG. 3. A structure and performance of the 49-cell cushion are similar to those of Example 7, and the cushion in this example is provided with more, smaller, and flatter airbags, such that an area of contact with the human body during use is enlarged, providing a different user experience. Due to high-barrier properties of the airbag material, and arrangement of a built-in inflation valve and a built-in deflation valve, the cushion is inflated for less times during use, and has a long service life.

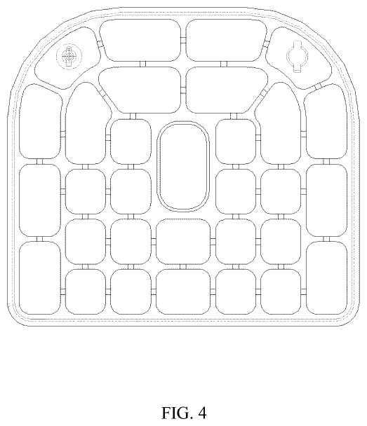

Example 9: A preparation process for a high-barrier inflatable cushion: an anti-decubitus cushion prepared according to the method disclosed in Example 1 is shown in FIG. 4. Airbags of the anti-decubitus cushion are arranged to meet needs of patients with decubitus or needing to prevent decubitus, which effectively enhances comfort of use. Due to high-barrier properties of the airbag material, and arrangement of a built-in inflation valve and a built-in deflation valve, the cushion is inflated for less times during use, and has a long service life.

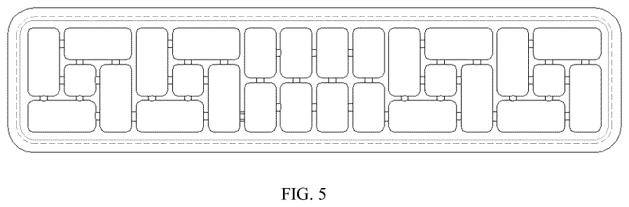

Example 10: A preparation process for a high-barrier inflatable cushion: a shoulder strap prepared according to the method disclosed in Example 1 is shown in FIG. 5. The shoulder strap is used as a strap for a load-bearing backpack, and an airbag thereof is closed without an inflation valve. Due to high-barrier properties of the airbag material, the shoulder strap has a long service life.

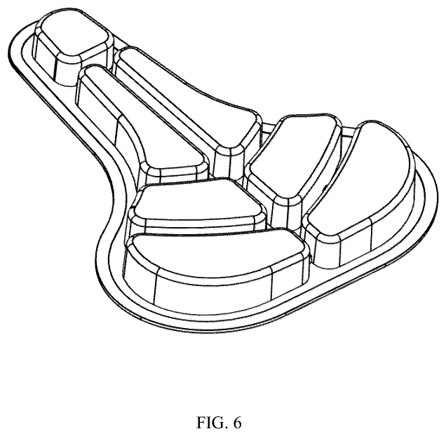

Example 11: A preparation process for a high-barrier inflatable cushion: a bicycle cushion prepared according to the method disclosed in Example 1 is shown in FIG. 6. A shape and airbag layout of the bicycle cushion are designed according to needs of a rider, and a built-in inflation valve and a built-in deflation valve are arranged on a back face of a top airbag. Due to high-barrier properties of the airbag material, and arrangement of a built-in inflation valve and a built-in deflation valve, the cushion is inflated for less times during use, and has a long service life.

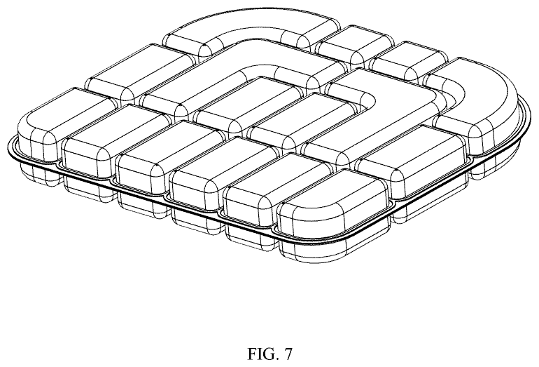

Example 12: A preparation process for a high-barrier inflatable cushion: a double-sided cushion prepared according to the method disclosed in Example 1 is shown in FIG. 7. The double-sided cushion is formed through vacuum adsorption and counter-pressure molding of an airbag forming material, and then thermal bonding of two identical semi-finished airbag products. A built-in inflation valve and a built-in deflation valve are arranged on a back face of either of two airbags in a middle along a top edge. Due to high-barrier properties of the airbag material of the present disclosure, the cushion is inflated for less times during use, and has a long service life.

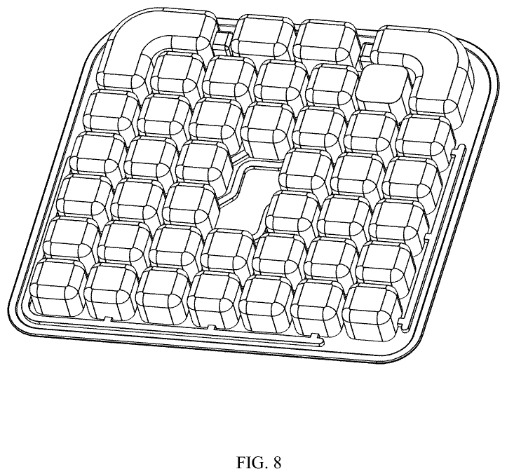

Example 13: A preparation process for a high-barrier inflatable cushion: an electric massage cushion prepared according to the method disclosed in Example 1 is shown in FIG. 8. The electric massage cushion is further provided with an electric massager inside an airbag. Due to high-barrier properties of the airbag material, the electric massage cushion has a long service life.

Comparative Example 1: A preparation process for a high-barrier inflatable cushion: in the preparation process of the airbag forming material and the airbag base material, the EVOH is an EVOH nanocomposite;
a preparation method for the EVOH nanocomposite includes the following steps: add 100 mg of a hybrid nanofiller into 250 mL of deionized water, perform ultrasonic dispersion, add 100 mL of a Tris-HCl buffer solution, stir evenly, add 100 mL of an aqueous dopamine hydrochloride solution, stir before reaction for 24 h, centrifuge to collect solid products, and freeze-dry to obtain a dopamine-modified hybrid nanofiller;
add 100 g of the EVOH copolymer into N,N-dimethylformamide, heat to 70° C. and stir evenly, cool to room temperature, sequentially add 5 g of the dopamine-modified hybrid nanofiller and an aqueous solution containing 5 g of boric acid, perform ultrasonic dispersion, add a mixture into a polytetrafluoroethylene container, heat to 70° C. for vacuum thermal treatment for 6 h, perform hydrazine vapor treatment, and perform vacuum drying at 50° C. to obtain the EVOH nanocomposite.

The remaining steps are the same as those in Example 1.

Comparative Example 2: A preparation process for a high-barrier inflatable cushion: in the preparation process of the airbag forming material and the airbag base material, the EVOH is an EVOH nanocomposite;
a preparation method for the EVOH nanocomposite includes the following steps: add 100 mg of MXene into 250 mL of deionized water, perform ultrasonic dispersion, add 100 mL of a Tris-HCl buffer solution, stir evenly, add 100 mL of an aqueous dopamine hydrochloride solution, stir before reaction for 24 h, centrifuge to collect solid products, and freeze-dry to obtain a dopamine-modified hybrid nanofiller;
add 100 g of the EVOH copolymer into N,N-dimethylformamide, heat to 70° C. and stir evenly, cool to room temperature, sequentially add 5 g of the dopamine-modified hybrid nanofiller and an aqueous solution containing 5 g of boric acid, perform ultrasonic dispersion, add a mixture into a polytetrafluoroethylene container, heat to 70° C. for vacuum thermal treatment for 6 h, perform hydrazine vapor treatment, and perform vacuum drying at 50° C. to obtain the EVOH nanocomposite.

The remaining steps are the same as those in Example 1.

Comparative Example 3: A preparation process for a high-barrier inflatable cushion: in the preparation process of the airbag forming material and the airbag base material, the EVOH is an EVOH nanocomposite;
a preparation method for the EVOH nanocomposite comprises the following steps: add 100 mg of a hybrid nanofiller into 250 mL of deionized water, perform ultrasonic dispersion, add 100 mL of a Tris-HCl buffer solution, stir evenly, add 100 mL of an aqueous dopamine hydrochloride solution, stir before reaction for 24 h, centrifuge to collect solid products, and freeze-dry to obtain a dopamine-modified hybrid nanofiller;
add 100 g of the EVOH copolymer into N,N-dimethylformamide, heat to 70° C. and stir evenly, cool to room temperature, add 5 g of the dopamine-modified hybrid nanofiller, perform ultrasonic dispersion, add a mixture into a polytetrafluoroethylene container, heat to 70° C. for vacuum thermal treatment for 6 h, perform hydrazine vapor treatment, and perform vacuum drying at 50° C. to obtain the EVOH nanocomposite.

The remaining steps are the same as those in Example 1.

Experiments: barrier properties testing: the TPU-EVOH composites prepared in Examples 1-6 and Comparative Examples 1-3 were used as test materials. The test materials were compressed to a thickness of 0.1 mm, a length of 200 mm, and a width of 200 mm. The barrier properties thereof were tested in accordance with GB/T 1038.1-2022, and experimental parameters include: a test area of 38.49 cm², a barrier property value ≥1, an upper chamber purging cycle of 607 sec, an upper chamber gas pressure of 9.898×10⁴ Pa, a lower chamber degassing duration of 60 sec, and a total degassing duration of 12 h for the upper and lower chambers, where the barrier properties are determined based on gas permeability.

Mechanical properties testing: the TPU-EVOH composites prepared in Examples 1-6 and Comparative Examples 1-3 were used as test materials, and tested by using a universal testing machine, with a tensile rate of 50 mm/min.

The experimental data are shown in Table 1.

TABLE 1
Properties testing data of raw materials
of high-barrier inflatable cushions

| | Gas | Tensile | Breaking |
|---|---|---|---|
| | permeability/ | strength/ | elongation/ |
| | cm³ · (m² · d · Pa)⁻¹ | MPa | % |
| Example 1 | 7.946 × 10⁻⁵ | 23.5 | 153 |
| Example 2 | 7.260 × 10⁻⁵ | 25.4 | 167 |
| Example 3 | 6.057 × 10⁻⁵ | 26.4 | 178 |
| Example 4 | 4.906 × 10⁻⁵ | 27.1 | 183 |
| Example 5 | 3.526 × 10⁻⁵ | 28.3 | 172 |
| Example 6 | 2.225 × 10⁻⁵ | 28.9 | 169 |
| Comparative | 6.557 × 10⁻⁵ | 25.2 | 167 |
| Example 1 | | | |
| Comparative | 6.453 × 10⁻⁵ | 25.4 | 168 |
| Example 2 | | | |
| Comparative | 6.778 × 10⁻⁵ | 25.5 | 170 |
| Example 3 | | | |

Conclusion: raw materials of the high-barrier inflatable cushions prepared in the present disclosure exhibit excellent barrier properties and mechanical properties.

In Comparative Example 1, the hybrid nanofiller is replaced with graphene oxide, which results in degradation of barrier properties and mechanical properties.

In Comparative Example 2, the hybrid nanofiller is replaced with MXene, which results in degradation of barrier properties and mechanical properties.

In Comparative Example 3, the aqueous boric acid solution is not added, which results in degradation of barrier properties and mechanical properties.

For those skilled in the art, it is apparent that the present disclosure is not limited to the details of the above-mentioned exemplary examples, and the present disclosure may be implemented in other specific forms without departing from the spirit or basic features of the present disclosure. Therefore, the embodiments should be regarded as illustrative and non-restrictive no matter from which point of view. The scope of the present disclosure is defined by the appended claims rather than the above specification, and therefore, it is intended that all changes which fall within the meaning and scope of equivalency of the claims are embraced in the present disclosure. Any reference numeral in the claims should not be construed as limiting the related claims.

What is claimed is:

1. A preparation process for an inflatable cushion, comprising the following steps:
S1: material feeding: feeding an airbag forming material with a thermoplastic polyurethane (TPU) layer unwound upward;
S2: heating: moving the airbag forming material to a heating chamber for heating;
S3: vacuum counter-pressure molding: after the heating, moving the airbag forming material to a molding chamber for vacuum adsorption and counter-pressure molding;
S4: spray cooling: after the molding, moving the airbag forming material to a spray chamber for spray cooling;
S5: air cooling and drying: after cooling, moving the airbag forming material to an air drying chamber for air cooling and drying;
S6: die-cutting: after the drying, moving the airbag forming material to a cutting area for cutting to obtain a semi-finished airbag product; and
S7: thermal bonding: thermally bonding one semi-finished airbag product with one airbag base material to obtain the inflatable cushion; wherein
the airbag forming material is prepared by laminating a TPU-ethylene-vinyl alcohol copolymer (EVOH) composite with Lycra fabric, and the airbag base material is prepared by laminating the TPU-EVOH composite with non-woven fabric.

2. The preparation process according to claim 1, wherein in the S2, a heating temperature is 350-400° C., and a heating duration is 15-30 sec; in the S3, a duration of the vacuum adsorption is 10-60 sec, and a duration of the counter-pressure molding is 80-100 sec; in the S4, a spray pressure during the spray cooling is 0.2-0.5 MPa, and a spray duration is 1-5 sec; and in the S5, a duration of the air cooling and drying is 50-100 sec.

3. An inflatable cushion, comprising an airbag forming material prepared by laminating a thermoplastic polyurethane (TPU)-ethylene-vinyl alcohol copolymer (EVOH) composite with Lycra fabric, and an airbag base material prepared by laminating the TPU-EVOH composite with non-woven fabric; wherein in the airbag forming material, the TPU-EVOH composite has a total thickness of 0.4-0.8 mm, and the Lycra fabric has a gram weight of 150-230 g/m²; and in the airbag base material, the TPU-EVOH composite has a total thickness of 0.1-0.3 mm, and the non-woven fabric has a gram weight of 60-80 g/m².

4. The inflatable cushion according to claim 3, wherein a preparation method for the airbag forming material or the airbag base material comprises the following steps:
co-extruding the EVOH material and the TPU material to obtain a TPU-EVOH composite; coating a moisture-curable polyurethane reactive (PUR) hot melt adhesive on an EVOH surface of the TPU-EVOH composite to obtain a bonding layer, heating the bonding layer to 120-140° C., laminating the Lycra fabric or the non-woven fabric on the EVOH surface, allowing same to stand for 24 h, and curing in an environment of 50-70% humidity and 15-30° C. for 4-7 d, to obtain the airbag forming material or the airbag base material; and the TPU material has a thickness of 0.15-0.8 mm, the EVOH material has a thickness of 0.02-0.05 mm, and the bonding layer has a peeling strength of 35-60 N.

5. The inflatable cushion according to claim 4, wherein the EVOH material comprises any one of EVOH, an EVOH copolymer, and an EVOH nanocomposite; and a preparation method for the EVOH copolymer comprises the following steps: adding (Z)-3-bromo-1-cyclooctene into a mixture of acetone and an aqueous sodium bicarbonate solution, heating and refluxing for 1-1.5 h, filtering and concentrating a filtrate, extracting with diethyl ether, separating an ether phase, drying and concentrating, and performing vacuum distillation to obtain 3-hydroxy-1-cyclooctene; adding the 3-hydroxy-1-cyclooctene and pyridine into dichloromethane, adding acetyl chloride under ice-bath conditions, stirring at room temperature for 3-3.5 h, adding a reaction mixture into 2 mol/L of a hydrochloric acid solution, separating an organic phase, extracting an aqueous phase with dichloromethane, washing the combined organic phase with a saturated aqueous sodium bicarbonate solution, drying with magnesium sulfate and concentrating, and performing vacuum distillation to obtain (Z)-cyclooct-2-ene-1-yl acetate; and
adding (Z)-cyclooct-2-ene-1-yl acetate into a reaction vessel, adding toluene, degassing through three cycles of freezing-pumping-thawing, adding argon, heating same to 40-42° C., adding a second-generation GRUBBS catalyst, maintaining a reaction for 24 h, adding ethyl vinyl ether to quench the reaction, adding the reaction mixture into methanol to separate the polymer, adding the polymer to dichloromethane, reprecipitating and purifying the polymer in methanol, adding 2,6-di-tert-butyl-p-cresol to the polymer, and performing vacuum drying at 70-72° C. for 24 h to obtain a polyolefin monomer, and hydrogenating and deprotecting the polyolefin monomer to obtain an EVOH copolymer.

6. The inflatable cushion according to claim 5, wherein in the preparation process of 3-hydroxy-1-cyclooctene, a concentration of the aqueous sodium bicarbonate solution is 0.03 mol/L; in the preparation process of (Z)-cyclooct-2-ene-1-yl acetate, a molar ratio of 3-hydroxy-1-cyclooctene to pyridine to acetyl chloride is 0.1:0.15:0.15; and in the preparation process of the EVOH copolymer, a molar ratio of (Z)-cyclooct-2-ene-1-yl acetate to the second-generation GRUBBS catalyst is 29.7:0.0074.

7. The inflatable cushion according to claim 5, wherein a preparation method for the EVOH nanocomposite comprises the following steps:
adding a hybrid nanofiller into deionized water, performing ultrasonic dispersion, adding a Tris-HCl buffer solution, stirring evenly, adding an aqueous dopamine hydrochloride solution, stirring before reaction for 24 h, centrifuging to collect solid products, and freeze-drying to obtain a dopamine-modified hybrid nanofiller;
adding the EVOH copolymer into N,N-dimethylformamide, heating to 70-72° C. and stirring evenly, cooling to room temperature, sequentially adding the dopamine-modified hybrid nanofiller and an aqueous boric acid solution, performing ultrasonic dispersion, adding a mixture into a polytetrafluoroethylene container, heating to 70-72° C. for vacuum thermal treatment for 6-7 h, performing hydrazine vapor treatment, and performing vacuum drying at 50-70° C. to obtain the EVOH nanocomposite; and
the hybrid nanofiller is prepared from 3-aminopropyltriethoxysilane modified MXene and graphene oxide.

8. The inflatable cushion according to claim 7, wherein in the preparation process of the dopamine-modified hybrid nanofiller, the Tris-HCl buffer solution has a pH value of 8.5; and in the preparation process of the EVOH nanocomposite, an amount of the dopamine-modified hybrid nanofiller added is 5-10 wt % of a mass of the EVOH copolymer, and an amount of boric acid added is 5-20 wt % of the mass of the EVOH copolymer.

9. The inflatable cushion according to claim 5, wherein a preparation method for the hybrid nanofiller comprises the following steps: adding lithium fluoride into a 9M hydrochloric acid solution, stirring evenly, adding titanium carbide aluminum powder under ice-bath conditions, heating to 35-36° C. for a reaction of 24 h, washing a reaction suspension with deionized water, centrifuging to collect a precipitate, washing the precipitate to neutral pH, performing ultrasonic dispersion of the precipitate in deionized water, centrifuging to collect a supernatant, purging with nitrogen, and freeze-drying to obtain MXene; and
adding MXene into an aqueous ethanol solution, performing ultrasonic dispersion under nitrogen conditions, adjusting a pH value of the suspension to 3-4, adding 3-aminopropyltriethoxysilane, stirring at room temperature for a reaction of 24 h, washing the suspension with ethanol, centrifuging, and freeze-drying to obtain modified MXene; and adding the modified MXene and graphene oxide into N,N-dimethylformamide, performing ultrasonic dispersion under the nitrogen conditions, adding carbodiimide, 1-hydroxybenzotriazole hydrate, and N,N-diisopropylethylamine, reacting under the nitrogen conditions for 24 h, washing a product with N,N-dimethylformamide and deionized water, and freeze-drying to obtain the hybrid nanofiller.

10. The inflatable cushion according to claim 9, wherein in the preparation process of the MXene, a mass ratio of lithium fluoride to titanium carbide aluminum is 1.95:2.9; in the preparation process of modified MXene, a mass ratio of MXene to 3-aminopropyltriethoxysilane is 1:2; and in the preparation process of the hybrid nanofiller, a mass ratio of modified MXene to graphene oxide to carbodiimide to 1-hydroxybenzotriazole hydrate to N,N-diisopropylethylamine is 125:125:67:67:1.
